(19) United States
(12) Patent Application Publication
(10) Pub. No.: US 2021/0130503 A1
(43) Pub. Date: May 6, 2021

(54) PROCESS FOR THE PRODUCTION OF HUMIC SUBSTANCES FROM BIOMASS

(71) Applicant: Schaltegger Projektplanungen, Caslano (CH)

(72) Inventors: Ernst SCHALTEGGER, Caslano (CH); Nikolaus FOIDL, Graz (AT)

(21) Appl. No.: 16/638,636

(22) PCT Filed: Jul. 31, 2018
(86) PCT No.: PCT/EP2018/070786

§ 371 Date: Feb. 12, 2020

Related U.S. Application Data
(60) Provisional application No. 62/558,051, filed on Sep. 13, 2017.

(51) Int. Cl. C08B 37/08; C08B 37/00; C08H 8/00

(52) U.S. Cl. CPC C08B 37/003; C08H 8/00; C08B 37/0003

(57) ABSTRACT

A process for the chemical synthesis of humic substances from biomass, includes carrying out a Maillard reaction by heating a first biomass for 1 to 30 minutes to 150-250° C. The soluble impurities obtained are extracted from a second biomass by water. The remaining first solid is torrefied under a protective gas atmosphere at 180-300° C. for 0.2 to 4 hours. A torrefied second solid obtained is heated with a solution of a strong inorganic acid in excess to 120-180° C. for 0.5 to 3 hours. The first reaction mixture obtained is filtered and washed with water.

### CROSS-REFERENCE TO RELATED APPLICATION

This application is a U.S. National Stage application of International Application No. PCT/EP2018/070786, filed Jul. 31, 2018, which claims priority to U.S. Provisional Patent Application No. 62/558,051, filed Sep. 13, 2017, the contents of each of which are hereby incorporated herein by reference.

### BACKGROUND

### Field of the Invention

The invention relates to a process for the chemical synthesis of humic substances from biomass. The invention further relates to a process for the chemical synthesis of chitosan from biomass.

### Background Information

Humic substances (HS) are natural, biogenic, heterogeneous, high-molecular organic substances with a yellow to black color having a rate of transformation or degradation in the ecosystem that is relatively low. Due to these recalcitrant properties, humic substances have a high residence time or lifespan in the environment. Humic substances are polyfunctional and ubiquitously distributed in soils, sediments and waters and form the major part of the total organic reservoir of these compartments.

Humic substances represent an important reservoir for organic carbon in aquatic and terrestrial environmental compartments; in surface waters, about 50% of the dissolved organic carbon (DOC) is attributed to humic substances and, despite their polydisperse character, they have typical physical and chemical properties which identify them as a group of substances. However, they do not fall into any discrete class of compounds such as proteins, polysaccharides or polynucleotides, but are operationally defined and named after the term humus. A fundamental interest in the structure and functionality of this substance class and in its significance for ecosystems is derived from the depot function, which is essential for life.

The interest in the composition and structure of these chemically heterogeneous, polydisperse and polyelectrolytic substances with molecular weights of a few hundred to several hundred thousand daltons [Da] is based in particular on their property to form compounds with many natural and anthropogenic chemicals, such as in complexation reactions with metal ions, due to the high number of functional groups (mainly carbonyl groups, hydroxyl groups, carboxyl groups and phenyl groups). Humic substances therefore play an important role in the transport, but also in the toxicity and bioavailability of metal ions in watercourses, river systems and soil, wherein the mobility depends on their molecular weights. The interactions and equilibria occurring in nature between metal ions in the dissolved phase and the colloidal phase of humic substances are complex because they are flow equilibria.

### SUMMARY

The characterization of humic substances with regard to their composition and structure is difficult because they are a polydisperse substance class and because conformations and complexation properties depend on parameters such as the pH value, the Eh value and the ionic strength.

Humic substances are formed by the decomposition of dead organisms and a subsequent humification process. HS are formed by different chemical and biochemical pathways under different natural conditions, which is why no binding genesis paths and reaction mechanisms can be specified.

Soils are the primary formation and action site for humic substances. However, humic substances have already been identified in leaves and plant parts in aging (senescence) without ground contact. By partial microbial decomposition of dead plant parts and animal residues as well as excrements of land and soil animals, aliphatic and aromatic individual building blocks, which are the starting materials for humic substances, are formed from high polymer compounds under the influence of enzymes. The transformation of organic substance into humic substances is called humification. The humic substance precursors (HsV) are formed from the aromatic fragments via radical intermediates in the so-called radical phase, in the course of which other inorganic and organic compounds present in the soil are also incorporated into the humic substance system. In this way, a system of non-uniform but stabilized natural substances is created.

Each particle can react with each other, which is why neither a linear reaction process nor a defined chemical constitution of the end products can be expected as a result of random events.

The composition, structures and properties of humic substances vary greatly due to the different pathways of formation and are dependent on the conditions of the environment in which they were formed. Table 1 describes typical properties.

Humic substances consist of different building blocks, mainly lignin, polysaccharides, proteins, OH-containing aromatic (poly) carboxylic acids, quinones, sugar fragments, oxygen-containing and nitrogen-containing heterocycles and different amino acids. The molecular units are linked together by different bridges (—O—, ═NH, ═CH2, —N═, ═C═O, —S—, also longer hydrocarbon chains) in different proportions. Despite their polydisperse character, humic substances have typical chemical and physical properties which identify them as a group of substances.

The properties of humic substances are closely related to the type and amount of functional groups they contain. Some functional groups are listed in Table 2 with their main origin and effect on the properties of humic substances.

Due to their heterogeneous composition, humic substances cannot be subdivided according to structural-chemical aspects. The substance class is instead divided into the fractions fulvic acid, humic acid and humins on the basis of an alkaline extraction. The humic substance fractions and their operational definitions are listed in Table 3. Fulvic acid, humic acid and humins are detectable after extractions from fossil parent substances such as Leonhardite or lignite and can also be characterized by standards. According to some research circles, these substances are part of a soil continuum model (SCM) in the soil and not present as such in a defined form. However, since the present invention produces humic acid and fulvic acid, and since these can be clearly characterized by standards, these terms are used in the following.

The fulvic acids differ from the humic acids of a sample essentially by their lower molecular weight, by the higher average oxygen content, lower carbon content and nitrogen content and by the mostly higher content of functional groups. The proportion of polysaccharide building blocks in fulvic acids can be up to 30%, aromatic components are hardly present. Fulvic acids as well as their salts, the fulvates, are water soluble and are able to dissolve under reduction metal ionic compounds having metals which can have several oxidation states, particularly preferably transition metals with several oxidation states such as iron (Fe(II)/Fe(III)), manganese (Mn(II)/Mn(IV)), cobalt (Co(II)/Co(III)), chromium (Cr(III)/Cr(VI)) and vanadium (V(III)/V(V)), especially manganese (IV) oxides and iron (III) oxides and to bind metal ion complexes.

The humic acids have a higher molecular weight, contain more aromatic components and methylene groups, but fewer polysaccharide fragments than fulvic acids. Humic acids are sparingly soluble in water and also form sparingly soluble compounds with polyvalent cations (calcium, magnesium, iron and aluminum), the so-called humates. The higher solubility in sodium hydroxide solution or potassium hydroxide solution is based in addition to the effect of the sodium cation/potassium cation on the fact that by dissociation of weakly acidic groups the pH-dependent charge of the humic acids is increased and thus the hydration is facilitated. Furthermore, existing bonds to other humates are dissolved by increasing the pH. As with fulvic acids, the acid character of humic acids and thus also their ability to exchange cations is mainly based on the presence of carboxyl groups and phenolic OH groups.

The large number of possible starting substances, the complex genesis and the absence of reaction control mechanisms are the reasons why humic substances do not have a uniform structural formula. It is assumed that no two identical molecules exist in a sample, at least for humic substances with a higher molecular mass. Even if it were possible to elucidate the structure of a humic substance particle, the result would not be very useful since the other molecules present in a sample have different structures. Thus, the properties of humic substances observed from the outside are to be understood as the sum of many different individual properties; this can also be seen in the characterization of humic substances. Wide mixed signals are obtained with different methods.

The degree of polydispersity can generally be reduced by fractionating humic substances. The fact that humic substances consist of a complex and heterogeneous mixture of compounds is demonstrated by the failed attempts to separate these materials into fractions of discrete compounds. With various separation methods only fractionations could be achieved which were able to determine and reduce the degree of heterogeneity of the samples, but none could isolate even approximately a material, which could be described as a pure humic substance (‘pure’ in the classical sense like ‘pure chemical’ or ‘pure group of chemicals’). In this respect, humic substances represent a unique category of natural substances, which is substantially characterized by their heterogeneity.

Nevertheless, it is useful for the description and understanding of the characteristics of humic substances to know structural models when one is aware of their weaknesses, especially the fact that they do not represent the reality.

The mineral retention function that is so important for the soil and the aquatic systems and also the plant system catalytic function of humic substances as well as the function of improving the soil structures and the retention capacity of water and nutrients, but also the partial binding and neutralization of pollutants, has led to the fact that more and more humic substances were promoted by extraction from peat, Leonhardite, lignite but also by the synthesis of humin-like substances from sugars and amino acids by low-temperature Maillard reactions.

The disadvantages of extractions and precipitates from Leonhardite, lignites and also peat are the heavy metal concentrations of mercury, lead, cadmium and other metal ions, which lead to very expensive and complex separation processes, as well as the low functionality of karrikins or butenoloids synthetically produced by Maillard reactions.

A further serious disadvantage is the low extraction efficiency from Leonhardite and lignite with high quantities of unreacted raw material, which additionally generates environmentally harmful residues or waste streams by the extraction method, which have to be neutralized separately and have to be stored in hazardous waste landfills.

Fresh organic substances from the current material cycles are often used for soil improvement.

Farm manure, e.g. stable manure, can be used in a simple manner to improve soil quality. Manure from stables has a soil-improving effect and provides the soil with nutrients. It has been shown that stable manure positively influences the water retention capacity of light sandy soils and the air balance of soils. However, the duration of action of stable manure is relatively short. Humic acids are only present up to 10% in cow dung. Residues from the fermentation of farm manure, green waste or organic waste can also be used for soil improvement.

It is also known to use compost, a rotting product from plant and animal waste. Accordingly, the nutrient contents of the different types of compost vary greatly. Compost has a high air capacity. Its water retention capacity is low. The biological degradation by soil-borne bacteria takes place within a few weeks. With regard to the starting material, only 3 to 10% of the introduced carbon is found as humic substance in the end product, the major part of the carbon goes into the air via CO₂ formation or is discharged into the sewage treatment plant during composting by leaching.

Various bark products such as bark mulch, bark humus and bark substrates are also proposed and used as organic soil improvers. Bark mulch is raw, unfermented (not composted) bark. Bark humus is composted bark. During the composting process, growth-inhibiting substances are converted into short-chain humus substances. Bark humus has both soil-improving and fertilizing effects. Bark substrates are finished culture substrates or plant soils treated with clay, peat or other aggregates and containing 30% to 60% bark humus. From FR-PS 2 123 042, FR-PS 2 224 421, DE-PS 2 651 171 and DE 3 040 040, processes for composting and humification of crushed bark have become known, to which additional inorganic nutrients or peat are added during the composting process in order to improve the product properties. However, all these products have a lower water retention capacity, i.e. more frequent watering is required. The adsorption of nutrients is also limited. The effect as permanent humus is limited, the degradation by soil bacteria also takes place within a few weeks as with compost.

Substrates from wood waste are also used for the improvement of soils. These specially treated wood waste products have, similar to bark humus, a low water retention capacity. Wood fiber materials that are not fertilized additionally have a lower nutrient content than bark humus. Untreated wood waste, such as sawdust or wood chippings, fix nitrogen in the soil, i.e. sufficient additional nitrogen must be added when spreading such substances. When using sawdust, it must be mixed very intensively with the soil, as sawdust nests prevent water from penetrating into the soil. Thus, the use of pure wood products for soil improvement is rather disadvantageous. For this reason, wood fiber materials are ofen fertilized or additionally used as growing media in mixtures with peat or clay.

In DE 101 23 903, it is proposed to use xylitol, which is the name for the remaining wood components in lignite, in digested form, in the digestion process in mills or extruders mixed with nutrients, substances for adjusting the pH value or clay materials in order to use the mixture as a soil improver. The proposed digestion process is very complex and limits the available humus components, which are available as food basis for microorganisms and for the plant growth to be aimed for. The exclusive use of peat products, which are characterized by their good water retention capacity and simultaneously high air content, is also known. As a result, peat is used as a raw material for the production of humic acid soil improvers in large quantities. Since it contains hardly any nutrients and has a low pH value, a targeted fertilization and lime treatment is necessary for various plant species.

While the provision of peat is associated with the destruction of valuable humid biotopes for rare animals and plants, lignite is available cheaply and in large quantities as a source of humic substance without significant additional environmental damage. The selection of humic acids from this and their use as soil improvers instead of peat can contribute to the fact that the habitats of the moorland areas are not irretrievably lost. In DE 101 20 433, a process for the production of permanent humus substances from soft lignite is described. Accordingly, soft lignite is to be mixed with clays or loams and subjected to wet digestion grinding or other thorough mixing. This substance is to be introduced into soils. Since the product produced does not contain any short- and medium-term available humus components despite the high expenditure, the resulting products are hardly suitable to contribute to soil improvement.

Another source of humic acids are substances from the coconut processing industry, in particular the short and dusty waste from fiber processing, which is otherwise difficult to use.

The classical method for obtaining humic acids is the extraction of peat or lignite with diluted aqueous sodium hydroxide solution or potassium hydroxide solution. The humates dissolve in the extraction solution and are separated from the non-dissolved peat or coal components by filtration, decantation or centrifugation. After acidification of the extract with excess mineral acid, water-insoluble humic acids are formed, which can be separated. For the use as soil improvers, mostly lignite is extracted with aqueous ammonia, as explained in U.S. Pat. No. 3,770,411. The obtained extract is subsequently neutralized with phosphoric acid and enriched with micronutrients. U.S. Pat. Nos. 3,111,404, 3,264,084 and 3,544,295 describe complex and expensive methods of producing dry ammonium humate fertilizers by treating lignite with phosphoric acid and then with ammonia as an extracting agent. All these processes have some disadvantages. Thus, only a small proportion of the humic acids is extracted with the weakly basic NH₃ and the largest humic acid proportion is lost with the carbon residue after its separation. In addition, a considerable technical effort is required to separate the alkaline humate coal suspension, because the fine coal particles are difficult to settle and can easily clog filters.

The extraction solutions obtained are highly diluted and must normally be concentrated by using energy for a further use as soil improvers.

In U.S. Pat. No. 4,319,041, it is described that coal containing humic acid is mixed with water and extracted with aqueous solutions of sodium hydroxide solution, potassium hydroxide solution or ammonia under stirring in such a way that the pH value remains in the range of 6.5-8. The process has been terminated after 40 hours. A highly diluted humate solution is obtained, which must also be separated from the coal residue and subsequently concentrated. In U.S. Pat. No. 3,076,291, lignite is extracted with diluted aqueous NH₃, KOH or NaOH solutions. The humate solutions, which are separated from the coal residue and subsequently concentrated and neutralized, are used as a means for improving the germination capacity of the seed. In the published patent application DE 19859068 A1 it is described that lignite is suspended in an aqueous ammoniacal medium with a pH value greater than 9 and is partially dissolved and oxidized in the aqueous ammoniacal medium.

The organic fertilizer is obtained as dispersion after thickening or drying. According to this process, the initial lignite can be mixed with additives of lignin- or cellulose-containing products from industry and forestry. The addition of macro- and micronutrients is also possible.

The process avoids the complex separation of humate solution and carbon residue but requires additional energy for thickening or drying the product and, due to the low basicity of NH₃ compared to alkali lye, it opens up only a small proportion of the humic acids contained in the coal. In order to increase the soluble amount of humic acid available for the plants, an additional oxidation step is built in instead, which means an increased technical effort and only a small increase in the amount of available humic acids.

In the patent WO2007/125492 A2, the oxidation of pure substances of the group of saccharides, sucrose, glucose and fructose is carried out with the help of increased pressure and temperature by blowing in air or oxygen. However, this is achieved with relatively expensive raw materials, and these raw materials must be refined to a degree free of heavy metals, which makes the resulting humic substances relatively expensive. Since in this application the molecular size by dialysis is additionally limited to 600 to 1000 Dalton, this type of production is very inefficient and therefore not suitable for agricultural purposes. The low molecular weight compounds generated/produced are only used for pharmaceutical purposes such as disinfection of the oral mucosa and decomposition of biofilms in the oral cavity.

With the present invention, the complex sugars of hemicellulose, cellulose, lignin and chitin can of course also be oxidized by blowing in atmospheric oxygen or pure oxygen into a pressure vessel under pressure increase and temperature increase after the torrefaction of the biomass, although the oxidation then proceeds more slowly but more controlled. The resulting humic substances, as in the pressure-less acid oxidation, are used entirely as fulvic acid or humic acid, and therefore this procedure is much more efficient than the WO2007/125492 A2. Due to the torrefaction, the reaction speed of the subsequent oxidation is slowed down to such an extent that a “run-away” of the oxidation reaction is prevented, which can easily be the case with the use of pure, refined sugar.

In U.S. Pat. No. 5,876,479, a soil improving substance based on humic acids is described, for the preparation of which an aqueous solution of humates is first mixed successively with sodium bicarbonate to lower the pH value, a protein source such as animal meal or blood, citric acid, yucca extract, lime and seaweed. This suspension is then fermented for 10 days.

The solution obtained after separation of insoluble components is used as a soil improving substance.

It is further known from the U.S. Pat. No. 2,317,991 that a fermented mixture of protein materials and humates can be used as a plant growth stimulator.

These processes have the disadvantages that highly diluted solutions are produced, which require high expenditure for transport to the application area, humates have to be purchased at high cost and the soil improver is produced in a time-consuming and odor-causing production process.

Finally, in DE 101 23 283 a process is described in which fine-grained lignite is digested in an alkaline solution and a stable humate-humic acid permanent humus nutrient suspension is produced after the addition of inorganic additives and/or neutralization substances without further treating steps. This product has proven itself in practice, but the effect is limited in extremely nutrient-poor soils.

In DE 20 2009 007 252 U1, the structure of humic acid-containing organic compounds (humine complexes) on the basis of bitumen emulsions is described for small-scale use.

The published patent application DE 43 25 692 A 1 describes the structure of a hydrophobic layer in the soil for the containment of evaporation, i.e. the evaporation of water from the soil. The approach in this patent is the containment of transpiration, i.e. the consumption via the plant itself.

A similar approach for the containment of evaporation is described in the process in the published patent application DE 33 18 171 A 1. Here, however, instead of a hydrophobic layer, a film is incorporated into the soil to limit or even prevent the evaporation of water.

In 1971, Mitscherlich et al described in the published patent application DE 22 65 298 the structure of a water-storing layer in the subsoil which makes water available to plants. The basis for such a layer is gas concrete and expanded clay aggregates of a certain size. However, such a process can only be used to a limited extent on a large scale. The Patent EP 13 58 299 B1 also describes a process for producing soils or separating layers for the containment of evaporation.

A number of inorganic and organic substances are used to increase the water storage capacity. The use of artificial inorganic and organic soil improvers in the form of polymers and hydrogels, which are capable of reversibly storing water is also increasing. In most cases, however, these substances can only be used to a limited extent for use in desert soils, because they are not heat-tolerant, are only UV-resistant to a limited extent and are no longer functional at high salt contents in the soil. In addition, a number of unanswered questions remain with regard to artificial soil improvers with respect to the metabolites that can arise during natural degradation or chemical conversion in the soil. The use of rock flours and clay minerals is also increasing, but their effect is limited; in some cases they still have antagonistic effects in the soil with regard to the availability of potassium and magnesium, because potassium and magnesium are stored in the two-layer and three-layer clay minerals in particular, which are no longer available to plants under dry soil conditions.

Humic acid can have a cation exchange capacity of between 200 and 700 meq/100 grams depending on the proportion distribution of the different building groups, while fulvic acids can reach between 500 and 1400 meq/100 grams. Humic substances are also very interesting due to their electrochemical redox properties, which are promising for the production of redox flow batteries.

It is therefore the object of the invention to produce humic substances from biomass and agricultural and wood-economical waste in closed processes, avoiding waste with (almost) 100 percent conversion of the raw materials into the desired target products, wherein the disadvantages known from the state of the art are to be avoided.

The object is met by a process for the chemical synthesis of humic substances from biomass with the features described herein, by a more alternative process for the chemical synthesis of humic substances from biomass with the features described herein and by a process for the chemical synthesis of chitosan from biomass with the features described herein.

In the following, biomass, in particular the first biomass, generally means: agricultural waste and wood waste, wood, bark, cereal straw, leaves, herbaceous plants, tree fungi, sewage sludge and other organic waste, as well as many other types of vegetable biomass. In the following, an alkaline earth hydroxide solution generally means a solution of KOH and/or NaOH in water, in particular a 0.1 to 2.0 molar solution of KOH and/or NaOH in water, especially a 1.0 molar solution of KOH and/or NaOH in water. In the following, a solution of strong inorganic acids generally means a solution of sulphuric acid and/or phosphoric acid and/or nitric acid, in particular a 0 to 40% solution of sulphuric acid and/or phosphoric acid and/or nitric acid, preferably a 15 to 35% solution of sulphuric acid and/or phosphoric acid and/or nitric acid, particularly preferably a 15 to 25% solution of sulphuric acid and/or phosphoric acid and/or nitric acid. In the following, a mother liquor generally is the liquid extract obtained after filtration and/or washing of a reaction mixture and/or of a solid. In the following, heating generally stands for heating up and holding at a certain temperature range.

In particular, torrefaction can also be heating. In the following, in a pressure vessel generally means in a vessel, which is suitable for performing a reaction under pressure and/or for carrying out under pressure. Under pressure means a pressure greater than the atmospheric pressure. In the following, oxygen generally means pure oxygen or a gas mixture with oxygen.

According to the invention, a process is proposed for the chemical synthesis of humic substances from biomass, in particular from a first biomass, the process comprising the following process steps. A Maillard reaction is carried out with the first biomass by heating the first biomass, in particular for 1 to 30 minutes, especially for 10 to 15 minutes, and in particular by heating to 150-250° C., especially to 160-220° C., particularly preferably to 170-190° C.

A Maillard reaction is a non-enzymatic browning reaction, which can also be observed, for example, when deep-frying and frying food. Here, amine compounds (such as amino acids, peptides and proteins) are converted into new compounds under the effect of heat with reducing compounds. A Maillard reaction according to the invention is preferably carried out in a temperature range between 160 and 200 degrees Celsius, and the residence time in this temperature range is usually between 0 and 60 minutes, and preferably between 15 and 30 minutes. In addition, depending on the type of the first biomass, the Maillard reaction can take place after a residence time of about 1 to 60 minutes, preferably 15 to 40 minutes, even more preferably 25 to 30 minutes, at a temperature level of 100 to 220 degrees Celsius, preferably 160 to 200 degrees Celsius, even more preferably 175 to 185 degrees Celsius.

The generated Maillard reaction of the first biomass thus takes place between sugars, starches and amino acids, peptides, proteins under heating. For this purpose, the first biomass can be finely ground in order to promote the Maillard reaction by increasing the surface area. Soluble impurities are extracted from the obtained second biomass, i.e. the solid obtained by the Maillard reaction of the first biomass, by means of water.

After the Maillard reaction, the water-soluble reaction products can in particular also be extracted from the obtained second biomass with hot water and then thickened.

The first solid remaining from the extraction of the second biomass is torrefied under a protective gas atmosphere at 180-300° C., in particular at 190-250° C., in particular torrefied for 0.2 to 4 hours, especially for 1.5 to 2.5 hours. The first solid should therefore be torrefied for several hours until the desired degree of drying/decomposition is reached. Torrefaction is the thermal treatment of biomass without air access, which can lead to a pyrolytic decomposition and/or drying. In the existing biomass of all processes according to the invention, aromatic structures are produced in the biomass by torrefaction, which later react further in the oxidation step.

The obtained torrefied second solid is heated with a solution of a strong inorganic acid in excess, preferably heated to 120-180° C., in particular to 110-170° C., especially to 130-165°, in particular heated for 0.5 to 3 hours, especially for 1.5 to 2.5 hours (acid boiling). Thereby, an oxidation takes place under formation of fulvic acid. Alternatively, the oxidation may also take place by oxidizing the torrefied second solid with another oxidizing agent, such as suspending the torrefied second solid with water and oxidizing it with the addition of oxygen, in particular in a pressure vessel, as described later in more detail in the alternative process according to the invention. Oxidizing agents such as hydrogen peroxide, in particular hydrogen peroxide in low concentration, are also suitable for the oxidation of biomass.

During the torrefaction of the first solid, the resulting wood vinegar fractions can be condensed separately at the same time.

During the torrefaction of the first solid, the also resulting Maillard products and karrikins as well as hydrolactones and strigolactones can be formed at the same time.

The first reaction mixture obtained after boiling the torrefied second solid with a solution of a strong inorganic acid is filtered and washed with water. The fulvic acid produced by oxidation can therefore be dissolved by washing the remaining solid until the washing water is pH neutral.

The aromatic structures produced during torrefaction are converted to aliphatic compounds by the oxidation step, or to aliphatic compounds with an aromatic “backbone”, i.e. aromatic partial structures.

The advantages of the process according to the invention are inter alia:
(almost) complete transformation without waste
high yields
efficient and cost-effective
easy to automate

The following steps can optionally be carried out as further additional process steps for a process according to the invention.

The third solid obtained from the first reaction mixture can be boiled and dissolved at 120 to 160° C., in particular at 130-150° C., with alkaline earth hydroxide solution. Here, for example, it can be boiled under reflux with 1-molar KOH.

The second reaction mixture obtained after boiling the third solid with alkaline earth hydroxide solution can be neutralized with sulfuric acid and/or nitric acid and precipitating solids can be separated off. By further lowering the pH value to a range from pH 0 to pH 2.5, in particular pH 2, humic acid can be precipitated from the first mother liquor obtained after the neutralization of the second reaction mixture.

From a second mother liquor obtained after precipitation of the first mother liquor, calcium sulfate and/or magnesium sulfate and/or potassium sulfate can be precipitated and/or separated at pH 0 to pH 1, in particular at pH 0, and/or the second mother liquor obtained can be concentrated and neutralized.

In order to obtain a high yield of karrikins in the Maillard reaction, the ratio of sugars to amino acids in the first biomass should be between 1:1 and 1:3, and preferably 1:2.

If there is too little sugar or amino acid (in relation to the amino acids or sugar) in the first biomass in a process according to the invention, the Maillard reaction cannot proceed completely. The content of sugar or amino acids can be increased by infiltrating sugar or amino acid into the first biomass. The amount of the missing substance is therefore increased in the raw material.

In a special embodiment, in which a high proportion of carotenoids is present in the raw material (in the first biomass), strigolactones and hydrolactones are formed as further reaction products during the process according to the invention, in particular high proportions of strigolactones and hydrolactones are formed.

The torrefaction of the first solid can be carried out in a temperature range of 180 to 300 degrees Celsius, preferably 190 to 250 degrees Celsius, even more preferably at 235 to 250 degrees Celsius. In doing so, the first solid can also be pyrolyzed. The torrefaction temperature can be maintained at a constant temperature for 1 to 4 hours, preferably 2 to 3 hours. Here, the torrefaction can be carried out under an inert protective gas such as carbon dioxide, argon, nitrogen or another known protective gases or under vacuum.

In a process according to the invention, the respective proportions of humic acids or fulvic acids in the end product can be controlled via the process temperature. At higher temperatures of the pyrolysis/torrefaction, higher proportions of fulvic acids are produced, as the formation of fulvic acids is favored at higher temperatures. At a low temperature of the pyrolysis/torrefaction, higher proportions of humic acid are produced, as the formation of humic acid at lower temperatures is favored.

The torrefied second solid obtained can be cooled under inert gas and/or can be supplied to an acid boiling under reflux, wherein the acid boiling temperature is between 110 and 180 degrees Celsius, preferably below 130 to 165 degrees Celsius.

The acids used in acid boiling may be an acid or a mixture of several acids, wherein preferably one of the acids or a mixture of one or more of the acids sulfuric acid, nitric acid, phosphoric acid or concentrated acetic acid or citric acid is used. Here, the acid concentrations in acid boiling can be from 1 mass percent to 40 mass percent, preferably 15 mass percent to 35 mass percent, and even more preferably 25 mass percent to 30 mass percent of the solids used. The material obtained from the acid boiling (first reaction mixture) can first be filtered and subsequently the filter cake obtained can be washed with distilled water to pH neutral, wherein the washing water is added to the filtrate of the first reaction mixture and subsequently the filtrate plus washing water is concentrated.

After the step of acid boiling, mineral salts precipitating during concentration can be separated by a further filtration and removed from the process as a fertilizer fraction, here mainly nitrates, phosphates, acetates, citrates and sulfates can result, depending on the type of acids used. Of course, these mineral salts can also precipitate further in later steps of concentration and then also be filtered off.

The third solid remaining after filtering of the first reaction mixture can be mixed with 0.1 normal to 2 normal KOH, preferably 0.5 normal to 1 normal KOH, during boiling with alkaline earth hydroxide solution, and boiled under reflux at a temperature range of 130 to 160 degrees Celsius for 1 to 3 hours.

All solids that enter solution (and are not filtered off or similar) during the process according to the invention form the humic acid fraction, wherein the solids are usually boiled until they all enter solution.

The humic acid of the second reaction mixture can be neutralized by adjusting a pH value of 8 to 9, preferably a pH value of 8.5, and after concentration, the resulting salts (e.g. potassium salts) can be separated by filtration. Here, potassium salts are to be understood, inter alia, as salts of potassium and other alkali metals as well as sodium and lithium.

The humic acid obtained can be successively oxidized to fulvic acid by adjusting a pH value of about 14. This step can be carried out in particular after neutralization of the second reaction mixture.

After neutralization, the humic acid and fulvic acid can be enriched with mineral ions or concentrated, in order to be subsequently further processed with a spray dryer into a powdery concentrate.

A further alternative process according to the invention for the chemical synthesis of humic substances from biomass, in particular from a first biomass comprises the following process steps.

A Maillard reaction is carried out by heating the first biomass, in particular for 1 to 30 minutes, especially for 10 to 15 minutes, and in particular by heating to 150-250° C., especially to 160-220° C., particularly preferably to 170-190° C.

Soluble impurities are extracted from a second biomass obtained by the Maillard reaction by means of water.

The first solid obtained after the extraction of the second biomass is torrefied under a protective gas atmosphere at 180-300° C., in particular at 190-250° C., in particular torrefied for 0.2 to 4 hours, especially for 1.5 to 2.5 hours.

The torrefied second solid is oxidized with an oxidizing agent, in particular suspended with water and oxidized with the addition of oxygen. This step can be carried out in particular in a pressure vessel.

The third reaction mixture obtained after oxidation is filtered and washed with water. As potential oxidizing agents, inter alia, oxygen, ozone, peroxides such as hydrogen peroxide, hypochlorite, perchlorate, percarbonate and iodine can be used.

Thus, it can be seen that the first alternative process differs from the process according to the invention described above only in the oxidation step. All further additional process steps described for the process according to the invention can therefore also be carried out for this process.

The oxidation step can be carried out by blowing air or oxygen into the 150 to 170-degree hot water—torrefied material mixture by using a stirred pressure vessel.

From the fourth mother liquor obtained after filtration of the third reaction mixture, calcium sulfate and/or magnesium sulfate and/or potassium sulfate can be precipitated and/or separated at pH 0 to pH 1, in particular at pH 0, and/or the fourth mother liquor obtained can be concentrated and neutralized.

According to the invention, a process is further proposed for the chemical synthesis of chitosan from biomass, in particular from a third biomass, wherein the process comprises the following process steps.

A Maillard reaction is carried out by heating the third biomass for 1 to 30 minutes, in particular for 10 to 15 minutes and to 150-200° C., in particular to 160-180° C. Soluble impurities are extracted from a fourth biomass obtained by the Maillard reaction of the third biomass by means of water. A fifth solid obtained after the extraction of the fourth biomass is boiled at 140 to 180° C., in particular at 150-170° C. with alkaline earth hydroxide solution.

A solid obtained after boiling the fifth solid with an alkaline earth hydroxide solution can be further processed as a second solid, the processing of which has already been described in the process according to the invention for the chemical synthesis of humic acid from biomass described above and the further additional process steps, which are also described above.

The following steps, in particular, can be carried out in a process according to the invention, which can be carried out one after the other. However, further intermediate steps can of course be carried out or, depending on the type of biomass, the chronology of the steps can be adapted. The descriptions below are a very precise outline of a possible process, which has already been outlined more broadly, with further optional and variable procedures. The following process steps also contain more detailed explanations on the usefulness of the process steps already described above, which can therefore also be applied to the procedures described above.

(Step 1) Since a great deal of the biomass types mentioned above have high sugar and protein contents, a Maillard reaction of the sugar or starch present, in the case of woody or straw-like biomass with appreciable hemicellulose contents, first produces a humin-like group of substances, namely butenolide or karrikins, by adding amino acids and heating them to 160 to 220 degrees Celsius, preferably 170 to 190 degrees Celsius. After several minutes, between 0 and 30 minutes, preferably 10 to 15 minutes, the Maillard reaction is completed to such an extent that the resulting products can be separated from the remaining solids by hot water extraction. The products of the Maillard reaction determine the amount of nitrogen and the amount of plant dormancy breaking karrikins in the final product.

(Step 2) The remaining solids after separation of the water-soluble products of the Maillard reaction are now torrefied in a temperature range between 200 and 280 degrees Celsius, wherein residence times are targeted at T=constant of 0.2 to 4 hours, preferably 1.5 to 2.5 hours. The torrefaction takes place under protective gas (CO₂, argon, nitrogen, etc.), wherein nitrogen is the preferred protective gas. The resulting wood vinegar fraction is condensed out via a condenser and supplied to the fertilizer or pesticide production process.

In embodiments using chitin-containing tree fungi or other chitin-containing fungi or fungi mycelia or other chitin-containing raw materials, after heating to 160 to 180 degrees Celsius and after water extraction of the resulting karrikins, the residual material is boiled under reflux with the help of KOH at 150 to 170 degrees Celsius and the resulting chitosan is recovered.

When using biomass with a high content of carotenoids, hydrolactones and strigolactones are also produced in addition to the already mentioned substances such as fulvic acid, humic acid, karrikins, etc.

Temperature and residence time control the composition ratio of fulvic acid and humic acids in the end product. At lower temperatures and shorter residence times, a higher proportion of humic acids is produced and at higher temperatures and longer residence times a higher proportion of fulvic acids. In addition, the ratio of the carboxyl-carbonyl-hydroxyl groups is controlled by the residence time.

(Step 3) The torrefied solid is now boiled under reflux with a mixture of several acids, preferably sulfuric acid, phosphoric acid and nitric acid with a concentration of 0 to 40%, preferably 15 to 35%, particularly preferably 25 to 30%, and oxidized. Boiling times at temperatures between 110 and 170 degrees Celsius, preferably 130 to 150 degrees Celsius are between 0.5 to 3 hours, preferably 1.5 to 2.5 hours. The addition of acid amounts to about 20% more than the acid consumption, so that after oxidation with the residual acid, further required minerals can be dissolved from the residual acid and can be added to the resulting fulvic acid as mineral fulvate. In doing so, it is possible to create tailor-made fulvic acid partitions with a precisely defined mineral composition.

Alternatively, a mixture of water and torrefied material can also be oxidized in a pressure vessel by blowing in air or pure oxygen, whereby there is not such a strong pH drop as with the use of acids for oxidation.

Depending on the concentration, the resulting fulvic acid is light yellow in high dilution at pH 0 and deep red in high concentration, and dark brown to black when neutralized with KOH to pH 6.5 to 7. This resulting fulvic acid is water-soluble in any pH range from 0 to 14 without filter residue.

When concentrating fulvic acid with pH 0, the precipitating gypsum (calcium sulphate, possibly also magnesium sulphate) can be fractionally separated by filtering if necessary and a separate tailor-made fertilizer mixture can be produced.

After concentration, the residual acid is neutralized with KOH and the precipitating salt is either left or separated by filtration or centrifugation and is used as a separate fertilizer fraction. Subsequently, the concentration of the liquid can be adjusted to the desired value with fulvic acid by further concentration or converted into a powdery solid by spray drying. The residual potassium amounts in the fulvic acid are between 1 to 15%, preferably less than 10%, depending on the course of the process.

(Step 4) The solid remaining after oxidation and separation of fulvic acid is washed with distilled water until the water is pH neutral. Subsequently, this washing water fraction, which still contains a relatively high proportion of fulvic acid and residual acids, is concentrated and neutralized and is added to the main fraction of fulvic acid.

The remaining solid consists of pure humic acid with attached minerals from the acid treatment such as phosphorus, sulfur and minerals from the raw material, which have not converted into the fulvic acid fraction. Small amounts of nitrogen can also be detected as NO₂ or NO₃ deposits. If a liquid humic acid fraction is desired, this solid is boiled under reflux in 1-molar KOH until it is completely dissolved.

Boiling times of 0.2 to 4 hours, preferably 1.5 to 3 hours, especially 2 to 2.5 hours at temperatures between 120 to 150 degrees Celsius, preferably 140 to 150 degrees Celsius are used. This liquid can then also be adjusted to the desired potassium content by concentrating.

When neutralized either with H₂SO₄ or HNO₃, potassium sulfate or potassium nitrate can be crystallized out, separated by filtration and the crystallized material can be added to the separate fertilizer fraction in the appropriate mixing ratio or used as the sole fertilizer.

The liquid humic acid precipitates completely as crystalline humate when the pH value is lowered to pH 2.

Usually, however, the liquid humic acid is only lowered to the desired pH range of 8 to 9, preferably pH 8.5, with the addition of acids, preferably one of the main acids sulfuric acid, phosphoric acid or nitric acid, further preferably sulfuric acid, with the formation of crystallizing potassium sulfate. The resulting potassium sulfate or potassium nitrate or potassium phosphate is removed by filtration or centrifugation and supplied to the fertilizer production.

During the entire process, no waste or polluting process waters are generated. The CO₂ also produced during torrefaction is fixed via carbonate formation as calcium carbonate, potassium carbonate or magnesium carbonate. The raw material or carbon fraction used is converted into humic substances and fertilizers up to 70% to 100%. A tailor-made composition of humic substances and fertilizers is possible in every variation.

The resulting humic and fulvic acids are characterized by high cation exchange capacities (KAK), which are usually well above 200 meq/100 g. KAK is an important parameter of soil fertility.

The process control and the chemicals allow costs to be reduced by an order of magnitude compared with humic substances from peat, Leonhardite, lignite or synthesis. Most of the biomasses used generate an additional contribution to costs in the form of disposal fees and thus additionally reduce the overall process costs.

### BRIEF DESCRIPTION OF THE DRAWINGS

The invention will be explained in more detail hereinafter with reference to the drawings.

FIG. 1 is an exemplary FTIR analysis using a sigma-humic acid standard.

### DETAILED DESCRIPTION OF EMBODIMENTS

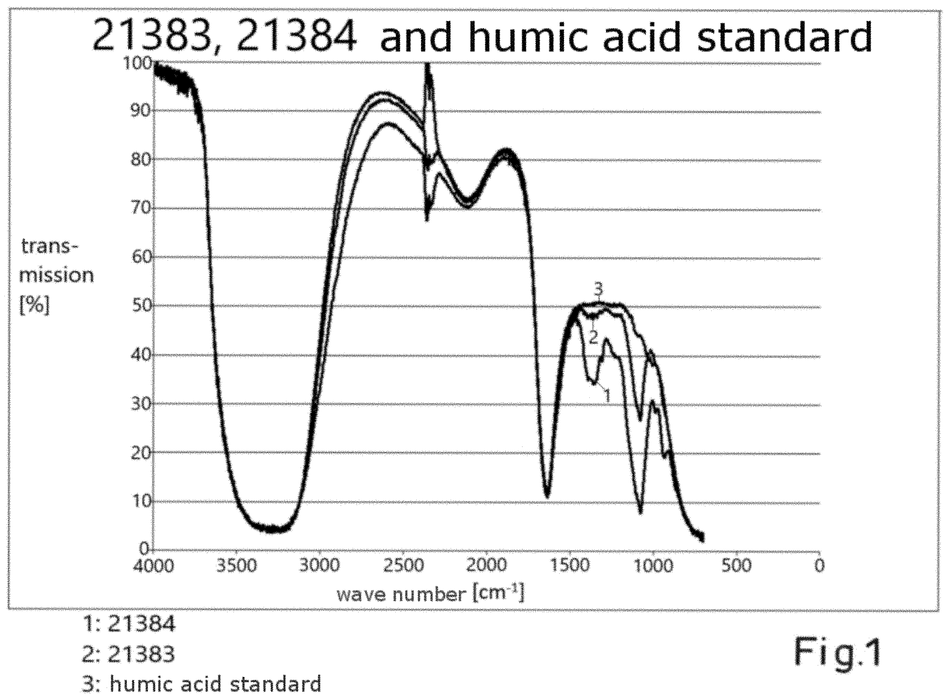

FIG. 1 shows an exemplary FTIR analysis by using a Sigma Humic Acid Standard 53680-10 g Charge No. NrBCBN1711V; CAS NR1415-93-6 compared to an FTIR analysis of the product of a process according to the invention. The FTIR analyses of the different humic acid samples yield almost congruent transmission curves in almost all wavelengths. As a consequence, a process according to the invention results in valuable combinations of humic acids, which largely correspond to the combinations of humic acids from the soil.

### ANNEX I: TABLES

TABLE 1
typical properties of humic substances
Properties of humic substances

| Keyword | Property | | |
|---|---|---|---|
| Molecular | high-molecular structures; some 100—several | | |
| weight | 100,000 g/mol | | |
| Element | | Average value | Fluctuation IV |
| contents | Element | [%] | [%] |
| | C | 54 | ±10 |
| | O | 33 | ±8 |
| | H | 4.5 | ±3 |
| | N | 2.7 | ±2.6 |
| | S | ≤2 | — |
| | P | <1 | — |

| | |
|---|---|
| Basic building | Aromatic and aliphatic structural elements, |
| blocks | phenolic hydroxy groups and ether bridges |
| Acid | Acid character due to —COOH and phenolic |
| | groups, ability to exchange cations |
| Polyelectrolytes | HS are polyelectrolytes |
| Complexing | due to various donor functions complexing agent |
| agents | for metal ions; traces of reversibly or in-eversibly |
| | bound metal ions are always present in HS |
| | Organic pollutants are bound by HS via hydrogen |
| | bridges or C—C— links. |
| Agglomerates | Formation of reversible agglomerates in solution, |
| | depending on the factors in the environment in |
| | dynamic equilibrium |
| Surface | Surface activity by hydrophilic and hydrophobic |
| activity | components |
| Spectroscopic | similar spectroscopic properties; UV spectra drop |
| properties | monotonously; IR spectra have wide, little |
| | characteristic bands; ¹H and ¹³C NMR spectra |
| | have wide signals |

TABLE 2
functional groups of humic substances: Origin and effect
Important functional groups of HS and their effects

| Functional group | | Main origin | Effect |
|---|---|---|---|
| —OH | Hydroxyl | Phenols, lignin | Acid |
| | (phenol) | | |
| —OH | Hydroxyl | Alcohols, coniferyl alcohol | Complex |
| | (alcohol) | (metabolic products) | formation, |
| | | | H-bridge |
| | | | formation |
| —COOH | Carboxyl | Carboxylic acid, amino acids, | Acid |
| | | (mostly oxidation products | |
| | | of carbohydrates and similar | |
| | | compounds) | |
| ═C═O | Carbonyl | Oxidation of phenols | Complex |
| | (quinone) | | formation, |
| | | | H-bridge |
| | | | formation |
| R—O—R | Ether | Carbohydrates, lignins | |
| —OCH₃ | Methoxyl | Lignins | |
| —NH₂ | Amino | Amino acid, amino sugar, | Complex |
| | | proteins | formation, base, |
| | | | H-bridge |
| | | | formation |

| | | |
|---|---|---|
| Heterocyclic N | Heterocycles, melanins | Complex |
| | | formation, base, |
| | | H-bridge |
| | | formation |

TABLE 3
operational definitions of humic substance fractions
Operational definitions of humic substance fractions

| Fraction | Definition |
|---|---|
| Humic | Organic substances precipitated from an alkaline |
| acids | humic substance extract at a pH value of ≤2 by the |
| | addition of acid. |
| Fulvic | Organic substance, which is not precipitated from an |
| acids | alkaline hurnic substance extract at a pH value of ≤2 |
| | after the addition of acid. |
| Humins | Insoluble part of humic substances in sodium |
| | hydroxide solution. |

TABLE 4
summary of the general properties of humic substance
fractions in the form of general tendencies
Humic substance fractions and their properties

| | Humic substance fraction | | |
|---|---|---|---|
| Characteristic | Fulvic acids | Humic acids | Humins |
| Color | yellow/yellow | brown/deep | black |
| | brown | brown | |
| C-content | 43-52 | 50-62 | >60 |
| [%] | | | |
| N-content | 0.5-2 | 3-8 | different |
| [%] | | | |
| Molecular | 800-9000 | Increasing | different |
| weight | | up to 10⁵ | |
| Molecular | More | More | different |
| building | polysaccharides | aromatics | (partly little |
| blocks | | | decomposed |
| | | | animal and |
| | | | plant residues) |

| | |
|---|---|
| Internal | Increasing from fulvic acids via humic |
| linking | acids to humins |
| Solubility | Decreasing from fulvic acids via humic |
| | acids to humins |
| Functional | Decreasing from fulvic acids via humic |
| group | acids to humins |
| O-content | Decreasing from fulvic acids via humic |
| | acids to humins |
| Acidity | Decreasing from fulvic acids via humic |
| | acids to humins |

1. A process for the chemical synthesis of humic substances from a first biomass,
the process comprising:
carrying out a Maillard reaction by heating the first biomass for 1 to 30 minutes to 150-250° C.;
extracting soluble impurities from a second biomass obtained from the carrying out the Maillard reaction by water;
torrefying a first solid remaining from the extracting soluble impurities under a protective gas atmosphere at 180-300° C. for 0.2 to 4 hours;
heating a torrefied second solid obtained from torrefying the first solid with a solution of a strong inorganic acid in excess; and to 120-180° C. for 0.5 to 3 hours
filtering and washing with water a first reaction mixture obtained from the heating a torrefied second solid.

2. The process according to claim 1, further comprising
boiling and dissolving a third solid obtained from filtering and washing with water the first reaction mixture at 120 to 160° C. with an alkaline earth hydroxide solution,
neutralizing a second reaction mixture obtained from the boiling and dissolving a third solid by sulfuric acid or nitric acid and separating off precipitating solids, or precipitating a humic acid by lowering and adjusting a first mother liquor obtained from the neutralizing a second reaction mixture from pH 0 to pH 2.5.

3. The process according to claim 1, further comprising precipitating or separating calcium sulfate or magnesium sulfate or potassium sulfate from a second mother liquor obtained in the filtering and washing with water at pH 0 to pH 1 or concentrating and neutralizing the second mother liquor obtained in the filtering and washing with water is.

4. The process according to claim 1, wherein a ratio of sugars to amino acids in the first biomass is between 1:1 to 1:3, so that a high yield of karrikins is obtained as a result of the Maillard reaction.

5. The process according to claim 1, wherein in absence of sugar or amino acids in the first biomass, a content of sugar or amino acids is increased by infiltration.

6. The process according to claim 1, wherein after the Maillard reaction is carried out, reaction products are extracted from the first biomass with hot water in the extracting soluble impurities and then thickened.

7. The process according to claim 1, wherein the torrefying the first solid is carried out under an inert protective gas such as carbon dioxide, argon, nitrogen or other known protective gases.

8. The process according to claim 1, wherein the torrefying the first solid is cooled under inert gas or is supplied to an acid boiling under reflux in the heating a torrefied second solid, and the acid boiling temperature is between 110 and 180 degrees Celsius.

9. The process according to claim 1, wherein at least one acid is used in the heating a torrefied second solid.

10. The process according to claim 1, wherein the humic acid obtained by precipitating the humic acid is neutralized by adjusting a pH value of 8 to 9, and after concentration, resulting salts are separated by filtration.

11. The process according to claim 2, wherein the humic acid obtained in the precipitating the humic acid is successively oxidized to fulvic acid by adjusting a pH value of about 14.

12. The process according to claim 10, wherein the humic acid and fulvic acid are used enriched with mineral ions or concentrated after neutralization to be subsequently further processed with a spray dryer into a powdery concentrate.

13. A process for the chemical synthesis of humic substances from a first biomass,
the process comprising:
carrying out a Maillard reaction by heating the first biomass for 1 to 30 minutes to 150-250° C.;
extracting soluble impurities from a second biomass obtained from the carrying out the Maillard reaction by water;
torrefying a first solid remaining from the extracting soluble impurities under a protective gas atmosphere at 180-300° C. for 0.2 to 4 hours;
oxidizing a torrefied second solid obtained from the torrefying the first solid with an oxidizing agent in a pressure vessel with the addition of oxygen, or oxidized with the addition of an oxidizing agent into the pressure vessel; and
filtering and washing with water a third reaction mixture obtained from the oxidizing the torrefied second solid.

14. The process according to claim 13, further comprising
boiling and dissolving a fourth solid obtained from filtering and washing with water the third reaction mixture at 120 to 160° C. with an alkaline earth hydroxide solution,
neutralizing a fourth reaction mixture obtained from the boiling and dissolving a fourth solid by sulfuric acid or nitric acid and separating off precipitated solids, or
precipitating a humic acid by lowering and adjusting a third mother liquor obtained from the neutralizing a fourth reaction mixture from pH 0 to pH 2.5.

15. The process according to claim 13, further comprising precipitating or separating calcium sulfate or magnesium sulfate or potassium sulfate from a fourth mother liquor obtained in the filtering and washing with water the third reaction mixture at pH 0 to pH 1 or the fourth mother liquor obtained in the filtering and washing with water the third reaction mixture is concentrated and neutralized.

16. A process for the chemical synthesis of chitosan from a third biomass,
the process comprising:
carrying out a Maillard reaction by heating the third biomass for 1 to 30 minutes to 150-200° C.;
extracting soluble impurities from a fourth biomass obtained from the carrying out the Maillard reaction by water; and
boiling a fifth solid obtained from the extracting soluble impurities at 140 to 180° C. with an alkaline earth hydroxide solution.
